(19) United States
(12) Patent Application Publication
(10) Pub. No.: US 2007/0067359 A1
(43) Pub. Date: Mar. 22, 2007

(54) Centralized system for versioned data synchronization

(75) Inventors: John William Barrs, Austin, TX (US); Michael Wayne Brown, Georgetown, TX (US); Paul Stuart Williamson, Round Rock, TX (US)

Correspondence Address: DUKE W. YEE;YEE & ASSOCIATES, P.C., P.O. BOX 802333, DALLAS, TX, 75380, US

(73) Assignee: Lenovo (Singapore) Pte. Ltd., Singapore (SG)

(21) Appl. No.: 11/232,371

(22) Filed: Sep. 21, 2005

(51) Int. Cl. G06F 17/30

(52) U.S. Cl. 707/203

(57) ABSTRACT

A computer implemented method, apparatus, and a computer usable program code for managing versioning of a set objects in a network data processing system. A first message is sent to a plurality of data processing systems to cause the plurality of data processing systems to generate delta data for the set of objects on the plurality of data processing systems in the network data processing system in response to a first event. The delta data is stored for each object in the set of objects to form stored delta data, and the stored delta data is subsequently used to return the set of objects to a prior version. A second message is sent to the plurality of data processing systems to cause the plurality of data processing systems to restore the set of objects back to the prior version using the stored delta data in response to a second event in managing versioning of the set of objects.

### BACKGROUND OF THE INVENTION

1. Field of the Invention

The present invention relates generally to an improved data processing system and in particular to a computer implemented method and apparatus for processing data. Still more particularly, the present invention relates to a computer implemented method, apparatus, and computer usable program code for managing versions of data.

2. Description of the Related Art

Data storage components, variables, collections, and multi-dimensional collections are used throughout all computer applications. During the execution of an application, the contents of these types of data storage elements will change or evolve. These changes occur due to modifications or updates to the data. These changes may be made by user input or through programmatic means. As the program logic of an application progresses, situations often arise in which the program state and the content of the data storage elements need to be reset to a prior state. This state may be an arbitrary state selected by the user or programmatically by an application. Mechanisms for incrementally saving and resetting data to a prior known state are present in many applications.

Currently available mechanisms are found in applications, such as word processors, for resetting or rolling back to a previous state. A word processor may allow a user to undo changes to a document, such as deletions, insertions, or formatting changes.

A significant problem with existing mechanisms is that they are prone to inefficiencies and require explicit management by the application programmer or end user. Therefore, it would be advantageous to have an improved method, apparatus, and computer instructions for data versioning and recovery management.

### BRIEF SUMMARY OF THE INVENTION

The present invention provides a computer implemented method, apparatus, and a computer usable program code for managing versioning of a set objects in a network data processing system. A first message is sent to a plurality of data processing systems to cause the plurality of data processing systems to generate delta data for the set of objects on the plurality of data processing systems in the network data processing system in response to a first event. The delta data is stored for each object in the set of objects to form stored delta data, and the stored delta data is subsequently used to return the set of objects to a prior version. A second message is sent to the plurality of data processing systems to cause the plurality of data processing systems to restore the set of objects back to the prior version using the stored delta data in response to a second event in managing versioning of the set of objects.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a block diagram of a Java virtual machine in accordance with an illustrative embodiment of the present invention;

FIG. 4 is a diagram illustrating components used in data versioning and recovery in accordance with an illustrative embodiment of the present invention;

FIG. 5 is a diagram illustrating components used in providing data versioning and recovery management in accordance with an illustrative embodiment of the present invention;

FIG. 6 is a diagram illustrating objects and a delta linked list in accordance with an illustrative embodiment of the present invention;

FIG. 7 is a diagram illustrating components used in managing versionable objects in accordance with an illustrative embodiment of the present invention;

FIG. 8 is a diagram illustrating components for a centralized system for managing versioning of data in accordance with an illustrative embodiment of the present invention;

FIG. 9 is a flowchart of a process for managing versioning data on objects in a network data processing system in accordance with an illustrative embodiment of the present invention;

FIG. 10 is a flowchart of a process for managing versioning data on a device in accordance with an illustrative embodiment of the present invention;

FIG. 11 is a flowchart of a process for monitoring events in accordance with an illustrative embodiment of the present invention;

FIG. 12 is a flowchart of a process for associating dependent objects in accordance with an illustrative embodiment of the present invention;

FIG. 13 is a flowchart of a process for storing delta data in accordance with an illustrative embodiment of the present invention; and

FIG. 14 is a flowchart of a process for returning a prior version of an object to a requester in accordance with an illustrative embodiment of the present invention.

### DETAILED DESCRIPTION OF THE INVENTION

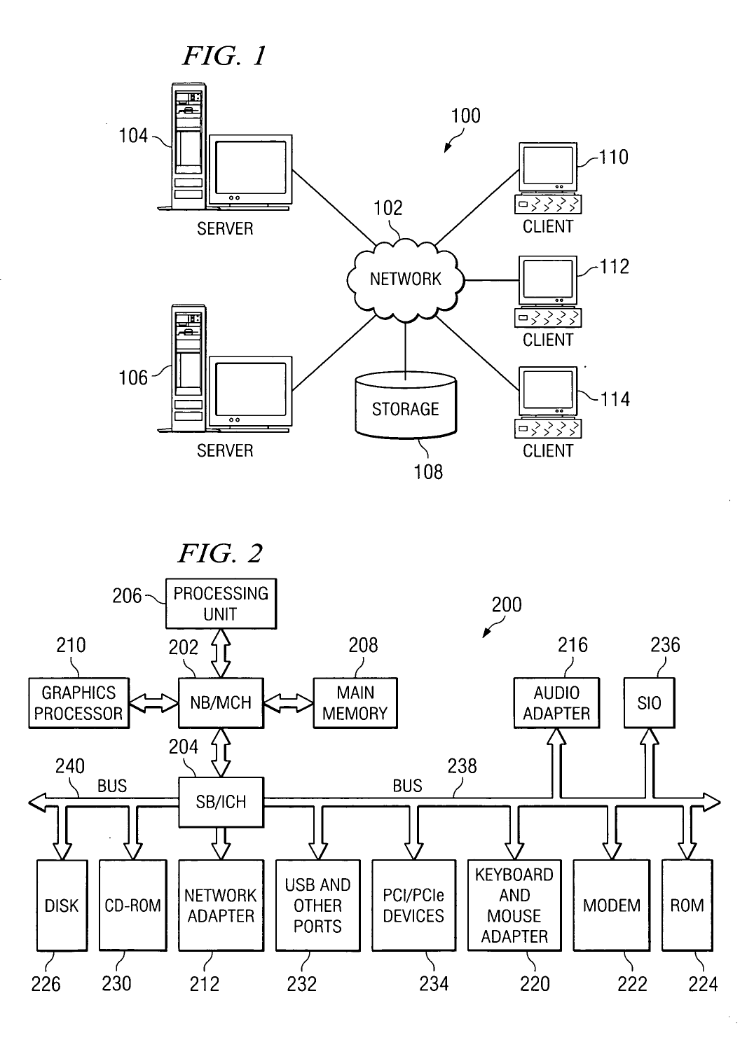

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

The aspects of the present invention provide for a computer implemented method, apparatus, and computer usable program product to manage the versioning of data in a network data processing system, such as network data processing system 100. In the illustrative examples, the versioning system implemented in network data processing system 100 is a centralized system in which all objects are dependent upon the state of a versionable object as specified using the aspects of the present invention. This type of versioning system may be used to return various objects within network data processing system 100 to a prior version in response to, for example, a detection of a virus. Additionally, this versioning system acts as a multi-caster for various versionable services in terms of generating versions of objects and restoring those versions in different clients or other resources within network data processing system 100.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

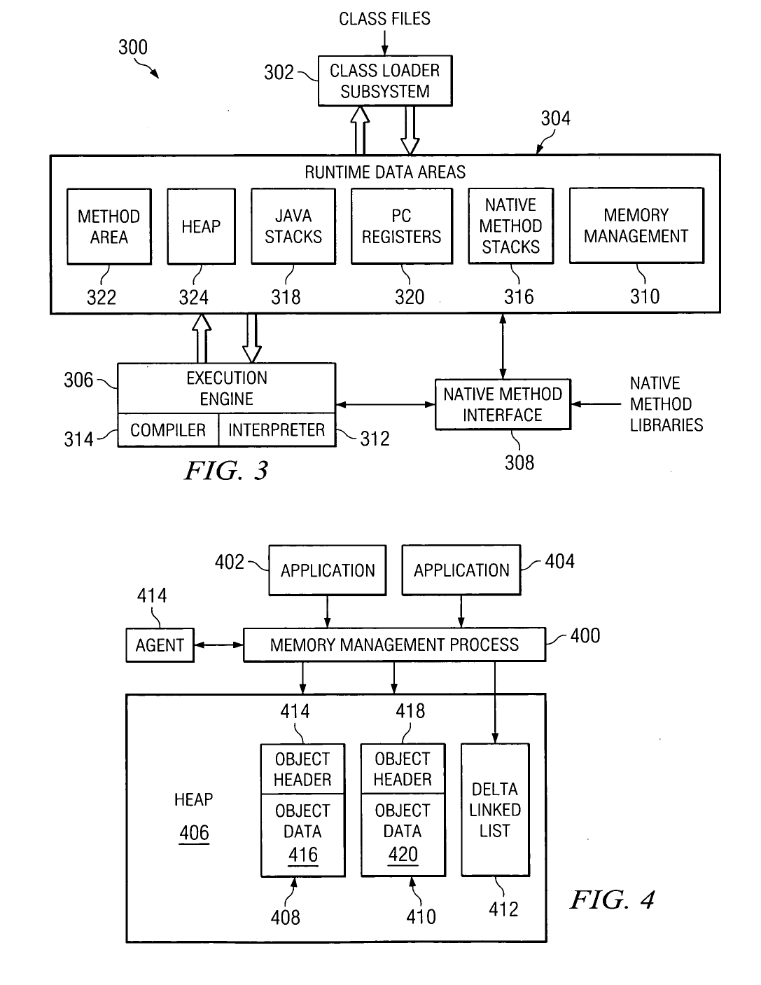

With reference now to FIG. 3, a block diagram of a Java virtual machine is depicted in accordance with an illustrative embodiment of the present invention. Java virtual machine 300 includes class loader subsystem 302, which is a mechanism for loading types, such as classes and interfaces, given fully qualified names. Java virtual machine 300 also contains runtime data areas 304, execution engine 306, native method interface 308, and memory management 310. Execution engine 306 is a mechanism for executing instructions contained in the methods of classes loaded by class loader subsystem 302. Execution engine 306 may be, for example, Java interpreter 312 or just-in-time compiler 314. Native method interface 308 allows access to resources in the underlying operating system. Native method interface 308 may be, for example, the Java Native Interface (JNI).

Runtime data areas 304 contain native method stacks 316, Java stacks 318, PC registers 320, method area 322, and heap 324. These different data areas represent the organization of memory needed by Java virtual machine 300 to execute a program.

Java stacks 318 are used to store the state of Java method invocations. When a new thread is launched, the Java virtual machine creates a new Java stack for the thread. The Java virtual machine performs only two operations directly on Java stacks: it pushes and pops frames. A thread's Java stack stores the state of Java method invocations for the thread. The state of a Java method invocation includes its local variables, the parameters with which it was invoked, its return value, if any, and intermediate calculations. Java stacks are composed of stack frames. A stack frame contains the state of a single Java method invocation. When a thread invokes a method, the Java virtual machine pushes a new frame onto the Java stack of the thread. When the method completes, the Java virtual machine pops the frame for that method and discards it. The Java virtual machine does not have any registers for holding intermediate values; any Java instruction that requires or produces an intermediate value uses the stack for holding the intermediate values. In this manner, the Java instruction set is well defined for a variety of platform architectures.

Program counter (PC) registers 320 are used to indicate the next instruction to be executed. Each instantiated thread gets its own PC register and Java stack. If the thread is executing a Java virtual machine method, the value of the PC register indicates the next instruction to execute. If the thread is executing a native method, then the contents of the PC register are undefined.

Native method stacks 316 stores the state of invocations of native methods. The state of native method invocations is stored in an implementation-dependent way in native method stacks, registers, or other implementation-dependent memory areas. In some Java virtual machine implementations, native method stacks 316 and Java stacks 318 are combined.

Method area 322 contains class data while heap 324 contains all instantiated objects. The constant pool is located in method area 322 in these examples. The Java virtual machine specification strictly defines data types and operations. Most Java virtual machines choose to have one method area and one heap, each of which is shared by all threads running inside the Java virtual machine, such as Java virtual machine 300. When Java virtual machine 300 loads a class file, it parses information about a type from the binary data contained in the class file. Java virtual machine 300 places this type of information into the method area. Each time a class instance or array is created, the memory for the new object is allocated from heap 324. Java virtual machine 300 includes an instruction that allocates memory space within the memory for heap 324 but includes no instruction for freeing that space within the memory. Memory management 310 in the depicted example manages memory space within the memory allocated to heap 324. Memory management 310 may include a garbage collector, which automatically reclaims memory used by objects that are no longer referenced. Additionally, a garbage collector also may move objects to reduce heap fragmentation.

The aspects of the present invention provide a memory management subsystem to provide for data versioning and recovery management. The aspects of the present invention save modifications or deltas in data when objects in memory are changed. A delta in data is the difference between the data in its prior version and its current version. The different deltas may be used to restore the objects to a prior state. In these illustrative examples, the memory management subsystem may be, for example, memory management 310 and heap 324 in FIG. 3. The aspects of the present invention modify this heap to include data structure for restoring delta data for objects. In these examples, delta data represents changed values or data for a particular object. This delta data is associated with an index. This index may take various forms, such as a number or a timestamp. This index also is referred to as a version identifier.

In particular, these changes between the prior data and the current data in its changed form are stored in a data structure, such as, for example, a linked list in a heap. The data structure is associated with an object. In the illustrative examples, an object is associated with the versioning data structure using at least one of a pointer and an offset. The aspects of the present invention, in these illustrative examples, modify the memory management system to automatically generate this linked list in the heap of a Java virtual machine without requiring any special requests from applications or the user.

Another feature in the aspects of the present invention is an ability to restore versionable objects in which an object being restored is associated with other objects that are dependent on the object being restored. The aspects of the present invention restore the associated objects that are dependent on the object being restored. These associated objects also are referred to as dependent objects. For example, when an object in the form of a spreadsheet is restored to a prior state, this spreadsheet may have links to or dependencies with other objects in the form of spreadsheets and rely on those other objects for data. If those other objects are not restored to the same state, the restoration of the spreadsheet may result in incorrect results being presented. Another example may be a personnel record application for a corporation in which division and department objects are stored. Division objects would have references to and dependencies on department objects. To restore a division object to a prior version would also require restoring the dependent department objects to the same prior version.

The aspects of the present invention provide a referencing system to associate these types of objects with each other. Additionally, the aspects of the present invention provide a mechanism to generate versions of dependent objects when a change occurs in one object that is dependent on these objects. In this manner, the dependent objects may be restored to the same version. In another aspect of the present version, the different types of versioning provided may be implemented on a distributed basis. For example, the versioning processes described herein may be implemented in a network data processing system, such as network data processing system 100 in FIG. 1. In particular, one or more data processing systems within network data processing system 100 may be employed to manage versioning processes for other data processing systems within the network.

More specifically, the aspects of the present invention provide a computer implemented method, apparatus, and computer usable program product for managing versioning of a set of objects in a network data processing system. A message is sent to data processing systems within network data processing system 100 in response to an event. This message causes the data processing system to generate delta data for a set of objects located on the data processing system. These objects may be distributed throughout the different data processing systems. These objects may be identical objects on each data processing system or may differ from data processing system to data processing system. The delta data is stored for each object in the set of objects to form stored delta data. This stored delta data may be subsequently used to return the set of objects to a prior version.

When another event occurs, a message is sent to the data processing system to cause these data processing systems to restore the set of objects back to the prior version using the stored delta data. In this manner, the versioning of the objects may be managed across a network data processing system.

Turning now to FIG. 4, a diagram illustrating components used in data versioning and recovery is depicted in accordance with an illustrative embodiment of the present invention. Memory management process 400 receives requests from applications, such as application 402 and application 404 to allocate objects. These objects are allocated from the available objects in heap 406. This heap may be, for example, heap 324 in FIG. 3. Memory management process 400 may be implemented in a memory management component, such as memory management 310 in FIG. 3.

In response to receiving these requests, data objects, such as data object 408 and data object 410, are allocated by memory management process 400. Additionally, delta linked list 412 is located within heap 406. This particular data structure contains a linked list of entries that identify delta data for various objects, such as object 408 and object 410.

In this example, object 408 includes object header 414 and object data 416. Object 410 includes object header 418 and object data 420. Object data 416 and object data 420 contain the data for objects 408 and 410 in their current state. Object header 414 includes a pointer or offset to delta linked list 412. In a similar fashion, object header 418 also includes an offset or header in the delta linked list 412.

If a request is received by memory management process 400 to restore one of the objects in heap 406 to a prior state, this process identifies the object and an index to identify the state that is desired. This index may be, for example, a numerical value or a timestamp. If, for example, object 408 is identified in the request, object header 414 is used to find delta linked list 412. This link list is managed by memory management process 400, which also calculates the delta data in these illustrative examples. The index in the request is used to identify the desired state for object 408. Based on the particular entry identified in linked list 412, linked list 412 may be traversed to make the appropriate changes to object 408 to return that object to its original state.

In these depicted examples, all of the delta data for all objects are stored within delta linked list 412. The entries that apply to a particular object may be identified through an object identifier that is found within each entry of delta linked list 412.

In other illustrative examples, a separate linked list data structure maybe used for each object. In this case, the object header provides an offset to the particular linked list data structure for that object.

When application 402 changes an object, such as object 408, memory management process 400 creates an entry within delta linked list 412 to store the delta data for that object. Memory management process 400 can detect changes in an object using a number of different mechanisms.

For example, when application 402 makes a call to assign a value to an object being managed by the memory management process 400, memory management process 400 detects this call and generates delta data. The delta data may be, for example, the difference between the old value and the new value. In another example, all of the objects are examined periodically to see whether a change has occurred since the last time data for the objects was stored in delta linked list 412. This comparison is made, in this example, by comparing the data in the object with a previous copy of the data for the objects. In yet another example, an explicit API call may be made to generate a change in the object. The receipt of this call is used to detect the change in data.

Specifically, any changed values in object 408 and object 410 are stored within delta linked list 412 in association with the identification of these objects and an index for each object. In these illustrative examples, the index may be a numerical value or a timestamp. In this manner, all changes to objects 408 and 410 are stored within delta linked list 412. Thus, these objects may be returned to any prior state desired using this data structure. Delta linked list 412 may include additional parameters other than an identification of the object and the index for the object. For example, delta linked list 412 may include references to dependent objects. In these depicted examples, the references may take the form of pointers to addresses or locations for those dependent objects.

The identification of dependent objects may be handled by memory management process 400 through an API call made through an application. For example, a user creating a spreadsheet that has links to other spreadsheet files for data may designate those spreadsheet files as dependent objects. In this particular example, the designations made by the user are sent by an API call made through the spreadsheet application to memory management process 400. As a result, memory management process 400 adds references to these objects.

When versions of the spreadsheet are made, versions of the dependent objects also are made. In a similar fashion, a restoration of the spreadsheet file to a previous version causes the dependent objects to be restored to the same version. In these examples, the references are stored in delta linked list 412. Of course, these references also may be stored in a separate data structure or location in association with the objects. In another illustrative example, the versioning of objects to create delta data may be initiated from calls made by agent 414 to memory management process 400. Agent 414 monitors for messages that originate from a centralized management process. In these examples, the centralized management process may be located on a data processing system in the network data processing system, such as server 104 in FIG. 1. Of course, the centralized management process may be located in any device or component within the network data processing system depending on the particular implementation. Additionally, agent 414 also may monitor for various events. For example, agent 414 may monitor for alerts, such as a detection of a virus. These different events may be returned to the centralized management system for processing. Based on those events, the centralized management system may send messages to agent 414 to return objects, such as objects 408 and 410 to a prior version.

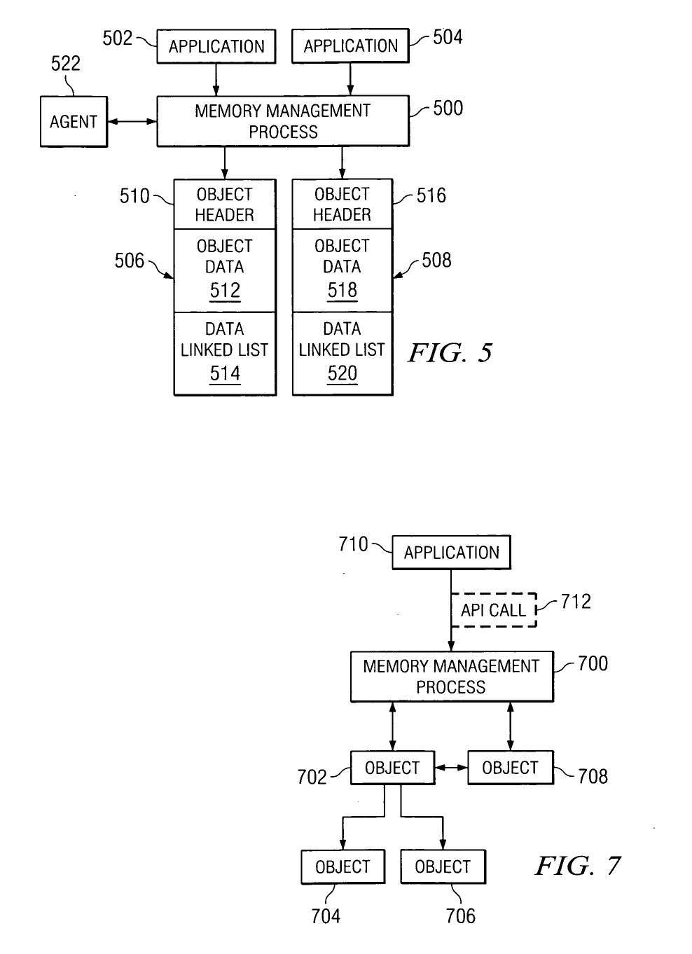

Turning next to FIG. 5, a diagram illustrating components used in providing data versioning and recovery management is depicted in accordance with an illustrative embodiment of the present invention. In this illustrative example, memory management process 500 receives requests from application 502 and application 504 to create objects for use by the applications. In this example, object 506 is created for use by application 502 and object 508 is created for use by application 504.

Memory management process 500 may be implemented within memory management 310 in FIG. 3. Objects 506 and 508 may be located in a heap, such as heap 324 in FIG. 3. Object 506 includes object header 510, object data 512, and delta linked list 514. Object header 510 includes an offset to point to the beginning of delta linked list 514 in this illustrative example. Object data 512 contains the current data for object 506. Delta linked list 514 contains entries that identify all of the delta data for object 506.

In a similar fashion, object header 516 provides an offset to the beginning of delta linked list 520. Object data 518 contains the current data for object 508. Delta linked list 520 contains all the delta data for changes made to object data 518. Additionally, information used to place objects into classifications also may be located within delta linked list 514 and 520. In this illustrative example, memory management process 500 automatically increases the size of object 506 in response to a request to allocate object 506. This increased size includes space needed to store delta data. This type of allocation for objects 506 and 508 is performed automatically without requiring an application or a user to request the additional memory to store delta data.

Additionally, memory management process 500 may allocate more space for object 506 and object 508 as the object data and the delta data increase for these objects. In this illustrative example, agent 522 may receive messages from a centralized management system to initiate the generation of versioning data and to restore objects to a prior version. Agent 522 initiates these processes by making calls to memory management process 500.

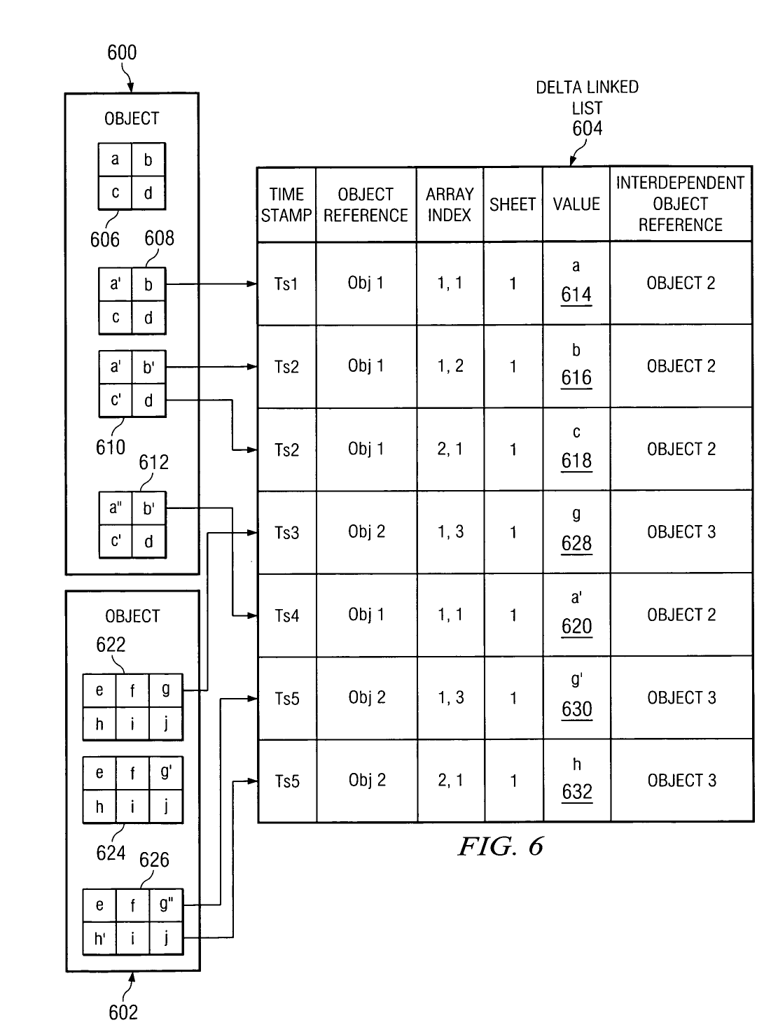

Turning now to FIG. 6, a diagram illustrating objects and a delta linked list is depicted in accordance with an illustrative embodiment of the present invention. In this example, object 600 and object 602 are examples of data elements requested by an application, such as applications 402 and 404 in FIG. 4. Space for object 600 and object 602 is allocated in a heap by a memory management subsystem. References to these data elements are returned to the applications for use. A reference may be, for example, a pointer to a data element or object in memory. Additionally, the memory management subsystem also initializes delta linked list 604.

In these illustrative examples, object 600 and object 602 are examples of spreadsheets. Object 600 is referred to as Obj 1, and Object 602 is referred to as Obj 2 in FIG. 6 in this example.

Array 606 represents the initial state of object 600. Array 608 indicates that a change has been made to the value in cell (1, 1). Array 610 indicates that changes have been made to object 600 in cells (1, 2) and (2, 1). Array 612 indicates that changes have again been made to object 600 in cell (1, 1). The initial change made in array 608 is stored as entry 614. Each of these entries includes a timestamp, which is used as the index. The entries also include an object reference to identify the object with which the entry is associated. These entries also include other parameters that may be used to designate other information or associations. For example, the different entries may include references to dependent objects.

The array index identifies the cell in which the change has been made. The value in the entry identifies the change value. In other words, when the value a is changed to value a′, the value a is stored in entry 614 to identify the delta between array 606 and array 608. The changes to array 610 are stored in entry 616 and 618. These two entries have the same timestamp because the changes were made at the same time by the application. Entry 620 identifies the change made to array 612 for object 600.

In a similar fashion, the data in object 602 is an example of a spreadsheet file and shows the different states of this object. Array 622 shows the initial state of object 602. Array 624 shows that a change has been made in cell (1, 3). Array 626 shows that a change has been made in cells (1, 3) and (2, 1) for object 602. The change made to array 624 is recorded in delta linked list 604 as entry 628. The changes made to array 626 are shown in entries 630 and 632 in delta linked list 604. In these examples, the changes are made to sheet 1 within the different spreadsheet files.

As can be seen, these examples illustrate that the index or state for the deltas is associated with timestamps. An entry is made each time a change is made to one of the objects in these examples.

The current state of object 600 is shown in array 612. The current state of object 602 is shown in array 626. As a result, if a user, an application, or some other process wishes to return object 600 to a prior state, delta linked list 604 may be used to perform this restoration.

In this illustrative example, the prior state is identified through a timestamp. If the memory management subsystem receives a request identifying a particular timestamp and object, the object may be returned to that state. In this example, if the timestamp is Ts2 for object 600, the memory management subsystem may identify the most recent delta for object 600 and return it to the prior state. For example, a″ in cell (1, 1) may be returned to a′ using entry 620. The mechanism of the present invention traverses the linked list from the most current entry to the entry identified by the timestamp. Entries for objects other than the selected object are ignored.

Next, the process identifies entries 616 and 618 as those corresponding to timestamp Ts2. The values for b′ in cell (2, 1) are returned to b and for c′ in cell (2, 1) are returned to c.

This type of traversal and restoration of data is provided as one manner in which the object may be restored to a prior state. Of course, any process used to return an object to a prior state using delta data may be employed in these illustrative examples.

The delta in data may be identified or calculated in a number of different ways. In these examples, the delta may be calculated using an exclusive OR (XOR). In other words, the value of prior data may be XOR'd with the value of the current data to identify the change in the current data as compared to the prior data. The result of this function is considered the delta in the data in this example. With this delta the current data may be restored to the value of the current data. The data may be, for example, the values for data in all of the heaps managed by a memory management system. The delta in the data also may be calculated using Moving Picture Experts Group (MPEG) processes, such as MPEG 2. With these processes every delta is similar to a video frame with respect to normal use in processing video data. Instead, the deltas are for one or more objects. As with a video, in which not every pixel necessarily changes from frame to frame, not all of the data elements within an object may change from one delta to another delta. Compression algorithms, similar to MPEG2, can be employed which minimize the amount of memory required to store the necessary information, or delta, to restore the objects to prior values.

Additionally, delta linked list 604 in these examples contains additional fields for references to dependent objects in each entry. In other words, each entry may contain references to a set of dependent objects. A set of dependent objects may contain one or more objects. These dependent objects are ones that the referencing object depends on for information. For example, a spreadsheet may be linked to another spreadsheet and depend on values calculated in these other spreadsheets to present correct values. As a result, referencing these dependent objects allows the aspects of the present invention to generate versions of the current object and objects referenced by that object to allow these objects to be restored to the same state at a later point in time. In this manner, the current object reflects the correct information if the current object is returned to that prior state.

Turning now to FIG. 7, a diagram illustrating components used in managing versionable objects is depicted in accordance with an illustrative embodiment of the present invention. In these examples, memory management process 700 manages and handles objects, including objects having dependent objects. Memory management process 700 may be implemented as memory management 310 in FIG. 3.

In this example, object 702 is dependent on object 704, 706, and 708. Object 708 is dependent on object 702. These dependencies are identified using references in a delta linked list, such as delta linked list 604 in FIG. 6. The entry or versioning data for object 702 includes references to objects 704, 706, and 708. The entry in a delta linked list for object 708 contains a reference to object 702.

A user creating object 702 using application 710 may identify dependent objects, which in this case are objects 704, 706, and 708 through API call 712. API call 712 also may be used to generate versions of object 702 and restore object 702 to a prior version. Each time a version of object 702 is generated, the memory management process identifies dependent objects associated with object 702 using the delta linked list. Memory management process 700 identifies object 704, 706, and 708 as dependent objects using references found in the delta linked list. Versions of these objects also are generated when a version of object 702 is generated. In these examples, the same version identifier is used for all of the objects.

Later, a user may restore object 702 to a prior version through application 710. Additionally, application 710 also may take the form of an agent. As an agent, application 710 sends calls to memory management process 700 to generate versions and restore versions of objects in response to messages received by the agent from a centralized versioning process. The request is sent as API call 712 to memory management process 700 in these examples. In turn, memory management process 700 identifies the delta between the current version and the requested version and restores object 702 to the requested version.

Additionally, memory management process 700 determines whether references to dependent objects are present for object 702. In these depicted examples, references to objects 704, 706, and 708 are present. Memory management process 700 restores these objects to the same version or state as object 702. As a result, object 702 may present the correct information or results in the prior state because the other objects also have been returned to the same prior state. In this manner, any data that object 702 depends on from objects 704, 706, and 708 also are corrected. In another example, object 708 contains a reference to object 702. As a result, if a user makes a request to restore object 708 to prior version, memory management process 700 restores object 708 to that prior version.

In addition, memory management process 700 also checks for references to dependent objects associated with object 708. In this example, object 702 is included as a reference in the delta linked list entry for object 708. Further, memory management process 700 also checks object 702 to determine whether object 702 has references to other objects that are dependent objects. Objects 704 and 706 are dependent on object 702 in this example. Those identified objects also are restored to the same version.

When a new version of object 708 is created, memory management process 700 checks the entry in the delta linked list for object 708 to identify any other referenced objects. In this illustrative example, object 702 is referenced as a dependent object in the entry for object 708. Memory management process 700 generates a version of object 702 to allow this object to be restored to the same state at a later point in time because object 702 is dependent to object 708.

Further, memory management process 700 also determines whether object 702 has references to dependent objects. In this example, object 704 and object 706 are identified. Object 708 also is referenced, but a version already has been made of this object. Memory management process 700 generates a version of object 704 and object 706. This traversal of references is performed until no more references are found. In this manner, all of the versioning data for all objects that are dependent with objects 708 directly or indirectly is made by memory management process 700.

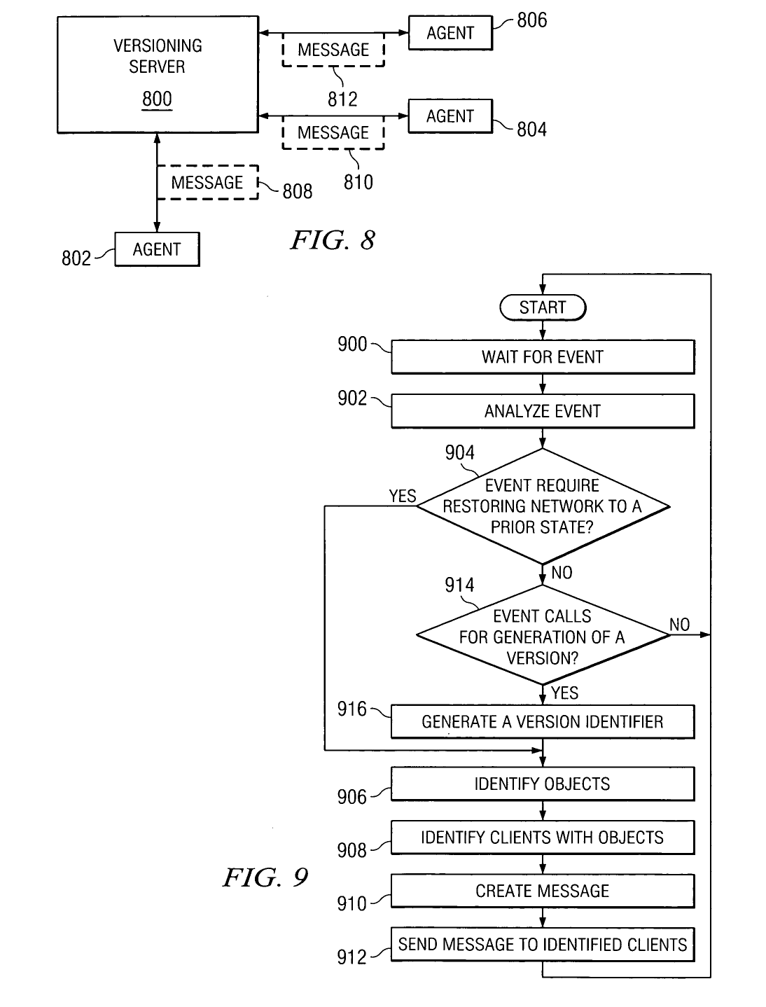

Turning now to FIG. 8, a diagram illustrating components for a centralized versioning system for managing versioning of data is depicted in accordance with an illustrative embodiment of the present invention. In these examples, a versioning server process is employed in a centralized versioning system along with agents to manage versioning data in a network data processing system such as network data processing system 100 in FIG. 1. As depicted, versioning server process 800 is in communication with agents 802, 804, and 806. Versioning server process 800 may send messages 808, 810, and 812 to agents 802, 804, and 806 respectively.

Messages sent to these agents have different functions. For example, the messages may contain a request to generate a version of objects on the different data processing systems on which these agents are located. Agents may be located on different data processing systems, such as, for example, storage 108, client 114, and server 106 in FIG. 1. These agents may be located on any data processing system on which objects are to be versioned. Additionally, these agents may be located on a router or switch that contains objects, such as routing tables or routing functions. The messages also may request that the agents initiate restoring objects to a prior version.

The agents also may send messages back to versioning server process 800. These messages may indicate, for example, that a version of objects have been made or that objects have been successfully returned to a prior version.

Also, the agents monitor for various events occurring on the different systems on which they are located. For example, agent 804 may detect an occurrence of a virus on the data processing system in which this agent is located. A virus may be detected using processes within agent 804 to actually scan for viruses. Alternatively, agent 804 may monitor for alerts generated by virus protector programs and removal programs on the data processing system.

Upon detecting this event, agent 804 may send a message to versioning server process 800. Depending on the conclusion of the analysis, versioning server process 800 may send a message back to agent 804 to restore objects in the data processing system back to a prior state. This restoration is made in an effort to return the system to a state prior to the virus being present.

Additionally, even though viruses are not detected on the other data processing systems, versioning server process 800 may send similar messages to agents 802 and 806 to initiate restoration of objects back to a prior state as a preventive measure. In sending messages to the agents, versioning server process 800 may broadcast these messages or direct them to particular agents.

In FIG. 9, a flowchart of a process for managing versioning data on objects in a network data processing system is depicted in accordance with an illustrative embodiment of the present invention. The process illustrated in FIG. 9 may be implemented in a centralized system, such as versioning server process 800 in FIG. 8. This centralized process may be located on a single data processing system or may be located on several data processing systems within the network data processing system.

The process begins by waiting for an event (step 900). The different agents monitor for and send events to the process. The events sent by the agents may vary depending on the particular implementation. For example, agents may send events indicating that viruses have been detected, an error has caused an operating system to restart, or that data corruption has occurred. When the event is received from an agent, the event is analyzed (step 902). A determination is made as to whether the event requires restoring the network to a prior state (step 904).

If the event requires restoring the network to a prior state, one or more objects on different data processing systems are identified for restoration (step 906). Depending on the particular determination, only objects on a single data processing system may require restoration to a prior version. In some cases, two or more, or all of the data processing systems in the network may have their objects restored to a prior state. The particular determination as to what objects and what data processing systems are to be involved in this restoration depends on the particular implementation.

Thereafter, clients with the objects selected for restoration are identified (step 908). A message is created (step 910) and sent to the identified clients (step 912) with the process returning to step 900 to wait for another event to be received.

With reference again to step 904, in some cases, the events may not call for restoring the network to a prior version. In that case, a determination is made as to whether the event calls for generation of a versioning of data for objects (step 914). If the event calls for generation of a version of data, a version identifier is generated (step 916). The process then proceeds to step 906 to identify objects and clients for which a version is to be generated.

With reference again to step 914, if the event does not call for generation of a version of data, the process returns to step 900 to wait for another event to be received.

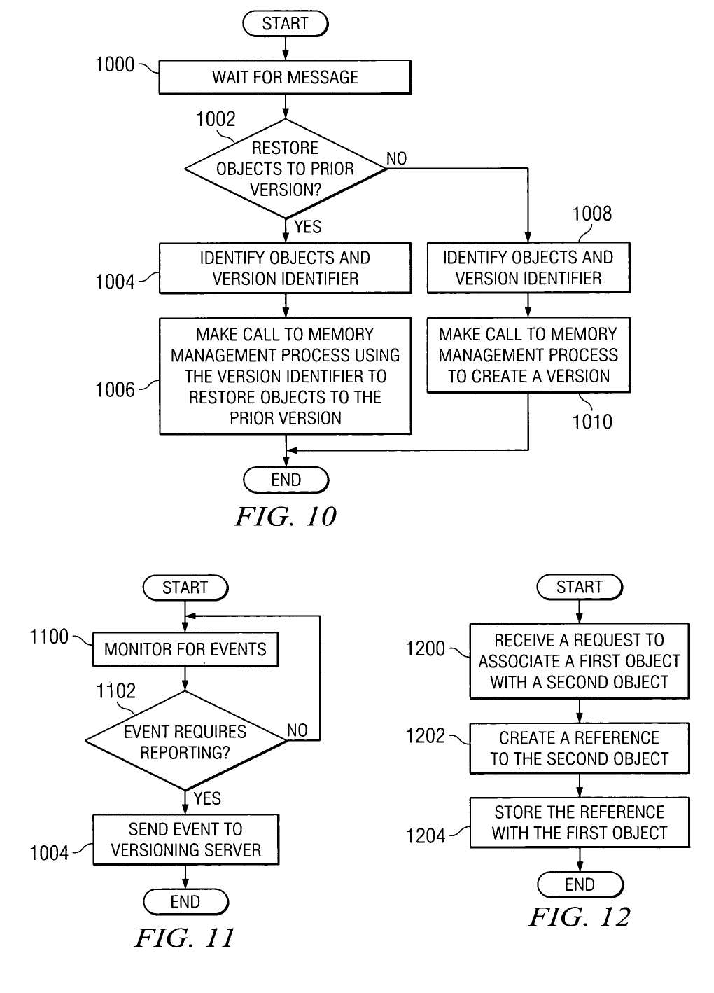

With reference next to FIG. 10, a flowchart of a process for managing versioning data on a data processing system is depicted in accordance with an illustrative embodiment of the present invention. The process illustrated in FIG. 10 may be implemented in an agent, such as agent 802 in FIG. 8.

The process begins by waiting for a message (step 1000). The agent monitors for messages that are either sent directly to the agent or broadcast by a versioning server process, such as versioning server process 800 in FIG. 8. When a message is received, a determination is made as to whether the message request is for restoring objects to a prior version (step 1002). If the message request is for restoring objects to a prior version, the process identifies the objects and the version identifier to be used (step 1004). The objects and version identifier may be included in the message received from the versioning server process. The process then makes a call to the memory management process using the version identifier to restore the selected objects to the prior version (step 1006) with the process terminating thereafter.

With reference again to step 1002, if the message is not to restore objects to a prior version, the message is for generating a version of objects in this example. The process then identifies the objects and a version identifier for use in generating a version of data (step 1008). Thereafter, a call is made to a memory management process to create a version of the identified objects using the version identifier (step 1010) with the process terminating thereafter.

Turning to FIG. 11, a flowchart of a process for monitoring for events is depicted in accordance with an illustrative embodiment of the present invention. In these examples, the process in FIG. 11 is implemented in an agent such as agent 802 in FIG. 8.

The process begins by monitoring for events (step 1100). The events monitored for may vary depending on the particular implementation. For example, the process may monitor for an event indicating that a virus has been detected. Alternatively, the event may be a message that the virus could not be removed by the virus engine located on the data processing system with the agent. Other events include, for example, an event indicating that an application has generated an error. The error monitor also may be a severe error indicating that the application will shut down or that the operating system will be restarted.

Upon detecting an event, a determination is made as to whether the event requires reporting (step 1102). The detected event may be compared to a list of events that should be reported. If the event is present on that list, the event is sent to the versioning server in the message (step 1104) with the process terminating thereafter. Otherwise, the process returns to step 1100 to monitor for additional events.

With reference now to FIG. 12, a flowchart of a process for associating dependent objects is depicted in accordance with an illustrative embodiment of the present invention. The process illustrated in FIG. 12 may be implemented in a memory management process, such as memory management process 700 in FIG. 7.

The process begins by receiving a request to associate a first object with a second object with the first object being dependent on the second object (step 1200). The process then creates a reference to the second object (step 1202). This reference is stored in association with the first object (step 1204) with the process terminating thereafter. In these examples, the process stores the reference in an entry in a delta linked list, such as delta linked list 604 in FIG. 6. This process is repeated for each object that is to be associated with the first object.

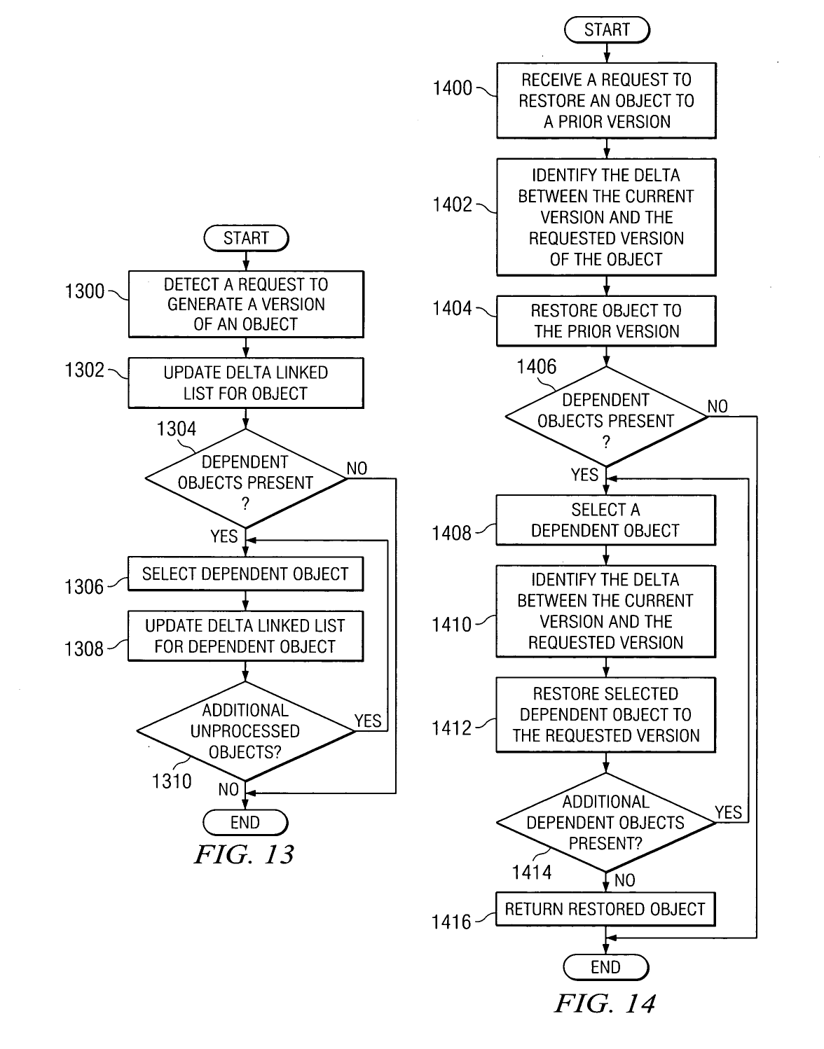

Turning now to FIG. 13, a flowchart of a process for storing delta data is depicted in accordance with an illustrative embodiment of the present invention. The process illustrated in FIG. 13 may be implemented in a memory management process, such as memory management process 700 in FIG. 7.

The process begins by detecting a request to generate a version of an object (step 1300). This step may occur in a number of different ways. For example, when the memory management process receives a request to change data in the object, the memory management process detects this call and generates delta data. This request or call may be received from an agent, such as agent 802 in FIG. 8 in these examples. Next, the memory management process updates the delta linked list for the object (step 1302). This updating includes creating an entry for the object if an entry is not present or placing the delta data in the delta linked list along with other identifying parameters needed to restore the object to this particular version at a later point in time.

Next, a determination is made as to whether dependent objects are present (step 1304). In this example, the determination is made by examining the entry for the object to see whether the references to other objects are present. If dependent objects are present, a dependent object is selected for processing (step 1306). The delta linked list for the dependent object is updated (step 1308). A determination is made as to whether additional objects are referenced as dependent objects in the entry in the delta linked list for the object (step 1310). If additional unprocessed objects are present, the process returns to step 1306. Otherwise the process terminates.

With reference again to step 1304, if references to dependent objects are not present, the process also terminates. When a change to a dependent object occurs in step 1308, the process in FIG. 13 is initiated for that object as being a change in an object. In this manner, all related objects needed to ensure accuracy of data for an object have delta data generated for the version.

With reference now to FIG. 14, a flowchart of a process for returning a prior version of an object to a requester is depicted in accordance with an illustrative embodiment of the present invention. The process illustrated in FIG. 14 may be implemented in a memory management process, such as memory management process 700 in FIG. 7.

The process begins by receiving a request to restore an object to a prior version (step 1400). In these examples, the request is received from a requester, such as an application making an API call to the memory management process. Next, the process identifies the delta between the current version and the requested version of the object (step 1402). The process then restores the object to the prior version (step 1404).

A determination is then made as to whether dependent objects are present (step 1406). This determination is made in these examples by examining the entry in the delta linked list for the object to see whether references to dependent objects are present in the entry. If dependent objects are present, the process selects a dependent object for processing (step 1408). The delta between the current version and the requested version is identified (step 1410). This requested version is the version requested for the object from which this object is dependent. In these examples, the version identifier for the requested version is the same for the object and the dependent objects. The process then restores the selected dependent object to the requested version (step 1412).

Then, a determination is made as to whether additional unprocessed dependent objects are present (step 1414). If additional unprocessed dependent objects are present, the process returns to step 1408. Otherwise, the process returns the restored object to the requester (step 1416) with the process terminating thereafter.

With reference again to step 1406, if dependent objects are not present, the process also terminates. In these examples, the process in FIG. 14 is initiated when additional dependent objects are identified and restored in step 1412. In other words, step 1412 restarts the process in FIG. 14 for that particular object in these examples. In this manner, all dependent objects are restored to the requested version.

Thus, the aspects of the present invention provide a computer implemented method, apparatus, and computer usable program code for versioning objects in a network data processing system. The aspects of the present invention allow for a centralized process located on a data processing system to control versioning of objects for all data processing systems in the network data processing system. These data processing systems may include, for example, client computers, storage devices, routers, firewalls, and switches. A versioning server process is used in conjunction with agents located on the different data processing systems to manage the versioning of objects on those data processing systems. The versioning server process may initiate the generation of versioning data or may initiate the restoration of objects to a prior version by sending messages to the different agents. These agents monitor for events and send messages identifying events back to the versioning server process. The agents may selectively send events back. For example, the agents may send back events that may require the generation of versioning data or the restoration of objects to a prior version for events as described above.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing versioning of a set objects in a network data processing system, the computer implemented method comprising:
responsive a first event, sending a first message to a plurality of data processing systems to cause the plurality of data processing system to generate delta data for the set of objects on the plurality of data processing systems in the network data processing system, wherein the delta data is stored for each object in the set of objects to form stored delta data and wherein the stored delta data is subsequently used to return the set of objects to a prior version; and
responsive to a second event, sending a second message to the plurality of data processing systems to cause the plurality of data processing systems to restore the set of objects back to the prior version using the stored delta data, wherein versioning of the set of objects is managed.

2. The computer implemented method of claim 1, wherein the first event is one of an update to the set of objects, an installation of the set of objects on the plurality of data processing systems; or a request to create a version from an application.

3. The computer implemented method of claim 1, wherein the second event is selected from one of a detection of a virus.

4. The computer implemented method of claim 1, wherein the initiating steps are implemented in a selected data processing system in the network data processing system.

5. The computer implemented method of claim 1, wherein the stored delta data is distributed across the plurality of data processing system in association with the set of objects distributed on the plurality of data processing systems.

6. The computer implemented method of claim 1, wherein the first message is an application programming interface call.

7. The computer implemented method of claim 1 further comprising:
responsive to receiving the first message at a data processing system in the plurality of data processing systems, generating associated delta data for each object located on the data processing system.

8. The computer implemented method of claim 7, wherein the generating step is implemented in a memory management process.

9. The computer implemented method of claim 1, wherein the second event a selected message from a particular object in the set of objects detecting one of a presence of a virus, an error causing an operating system to restart, an application error, or data corruption.

10. The computer implemented method of claim 1, wherein the first message and the second message are sent to the plurality of data processing systems using a multicast process.

11. A network data processing system comprising:
a communications fabric;
a central data processing system connected to the communications fabric;
a plurality of data processing systems connected to the communications fabric;
a set of objects located on data processing systems within the plurality of data processing systems;
wherein the central data processing system sends a first message to the plurality of data processing systems to cause the plurality of data processing systems to generate delta data for the set of objects on the plurality of data processing systems, store the delta data for each object in the set of objects to form stored delta data; and
wherein the central data processing system sends a second message to the plurality of data processing systems to cause the plurality of data processing systems to restore the set of objects back to the prior version using the stored delta data.

12. A computer program product comprising:
a computer usable medium having computer usable program code for implementing a method for managing versioning of a set objects in a network data processing system, said computer program product including:
a computer usable program code, responsive to a first event, for sending a first message to a plurality of data processing systems to cause the plurality of data processing systems to generate delta data for the set of objects on the plurality of data processing systems in the network data processing system, wherein the delta data is stored for each object in the set of objects to form stored delta data and wherein the stored delta data is subsequently used to return the set of objects to a prior version; and
a computer usable program code, responsive to a second event, for sending a second message to the plurality of data processing systems to cause the plurality of data processing systems to restore the set of objects back to the prior version using the stored delta data, wherein versioning of the set of objects is managed.

13. The computer program product of claim 12, wherein the first event is one of an update to the set of objects, an installation of the set of objects on the plurality of data processing systems; or a request to create a version from an application.

14. The computer program product of claim 12, wherein the second event is selected from one of a detection of a virus.

15. The computer program product of claim 12, wherein the computer usable program code, responsive to a first event, for initiating sending a message to a plurality of data processing systems to cause the plurality of data processing system to generate delta data for the set of objects on the plurality of data processing systems in the network data processing system, wherein the delta data is stored for each object in the set of objects to form stored delta data and wherein the stored delta data is subsequently used to return the set of objects to a prior version are implemented in a selected data processing system in the network data processing system.

16. The computer program product of claim 12, wherein the stored delta data is distributed across the plurality of data processing systems in association with the set of objects distributed on the plurality of data processing systems.

17. The computer program product of claim 12, wherein the first message is an application programming interface call.

18. The computer program product of claim 12 further comprising:
a computer usable program code, responsive to receiving the first message at a data processing system in the plurality of data processing systems, for generating associated delta data for each object located on the data processing system.

19. The computer program product of claim 18, wherein the computer usable program code, responsive to receiving the first message at a data processing system in the plurality of data processing systems, for generating associated delta data for each object located on the data processing system, is implemented in a memory management process.

20. The computer program product of claim 12, wherein the second event is a selected message from a particular object in the set of objects detecting a presence of a virus.
